(19) United States
(12) Patent Application Publication
(10) Pub. No.: US 2006/0245817 A1
(43) Pub. Date: Nov. 2, 2006

(54) Pen with structure for picking up compact disk

(75) Inventor: Tien-Lai Lin, Taipei (TW)

Correspondence Address: BIRCH STEWART KOLASCH & BIRCH, PO BOX 747, FALLS CHURCH, VA, 22040-0747, US

(73) Assignee: CASE PAX INTERNATIONAL CO., LTD.

(21) Appl. No.: 11/116,403

(22) Filed: Apr. 28, 2005

(51) Int. Cl. B43K 29/00; B43K 23/02

(52) U.S. Cl. 401/195; 401/131

(57) ABSTRACT

A pen is provided at a first end with a writing element and at a second end distantly opposite to the first end with an engaging mechanism for picking up a compact disk via a central hole of the compact disk. The engaging mechanism includes a plurality of retaining lugs that together define an outer circumference adapted to interfere with an inner circumference of the central hole of the compact disk to thereby hold the compact disk to the retaining lugs, allowing the pen to pick up the compact disk.

### FIELD OF THE INVENTION

The present invention relates to a pen, and more particularly to a pen with structure for picking up a compact disk.

### BACKGROUND OF THE INVENTION

FIGS. 1 and 2 are top and bottom perspective views, respectively, of a general compact disk 1. As shown, the compact disk 1 includes a central hole 11, a front side 12, a reverse side 13, and a data area 14 extended from a radially outer position close to an inner circumference of the central hole 11 to a radially inner position close to an outer circumference 15 of the compact disk 1. Normally, the front side 12 of the compact disk 1 has designs and/or letters printed thereon, and data may be read from or written into the data area 14 via the reverse side 13 of the compact disk 1 using an optical element (not shown).

When the compact disk 1 is not in use, it is normally stored in a compact disk containing bag to protect the front and the reverse side 12, 13 of the compact disk 1 against wearing, scratch, and/or wet resulted mold. Generally, there are two ways to pick up a compact disk 1 temporarily positioned on a flat surface, such as a desktop.

The first way is shown in FIG. 3. The compact disk 1 is picked up with nails of a thumb and at least one finger, which are stretched to locate at the outer circumference 15 and the central hole 11 of the compact disk 1, respectively. When the thumb and the finger apply forces in two opposed directions, the compact disk 1 can be picked up without getting the front and the reverse side 12, 13 contacted with the thumb and the finger.

The second way is shown in FIG. 4 and suitable for users of old men and small children who have weak and small hands, respectively. The compact disk 1 is picked up with a thumb and at least one finger contacting with the front and the reverse side 12, 13 of the compact disk 1, so that the compact disk 1 is clamped between the thumb and the finger.

In the first way shown in FIG. 3, since the nails of the thumb and the finger have only very small force-applying areas, the compact disk 1 picked up in this manner tends to slip off the fingers, particularly when the user has short nails. In the second way shown in FIG. 4, the user's fingerprints tend to smudge or even damage the surfaces of the compact disk 1 to result in a data area that is no longer readable with the optical element.

It is therefore tried by the inventor to develop a pen with structure for picking up compact disk to eliminate the above-mentioned problems.

### SUMMARY OF THE INVENTION

A primary object of the present invention is to provide a pen with structure for conveniently picking up a compact disk without damaging the same.

To achieve the above and other objects, the pen of the present invention is provided at a first end with a writing element and at a second end distantly opposite to the first end with an engaging mechanism for picking up a compact disk via a central hole of the compact disk. The engaging mechanism includes a plurality of axially projected retaining lugs that together define an outer circumference adapted to interfere with an inner circumference of the central hole of the compact disk to thereby hold the compact disk to the retaining lugs, allowing the pen to pick up the compact disk.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a top perspective view of a general compact disk;

FIG. 2 is a bottom perspective view of the compact disk of FIG. 1;

FIG. 3 shows a first way of picking up a compact disk with at least two fingers;

FIG. 4 shows a second way of picking up a compact disk with at least two fingers;

FIG. 5 is a perspective view of a pen with structure for picking up compact disk according to a preferred embodiment of the present invention;

FIG. 6 is a top view of the pen of FIG. 5 showing a plurality of retaining lugs are provided on an end of the pen for picking up a compact disk;

FIG. 7 is a sectional view taken along line a-a of FIG. 6;

FIG. 8 is a sectional view showing the retaining lugs on one end of the pen of the present invention are aligned with a central hole of a compact disk to be picked up;

FIG. 9 shows the retaining lugs are axially moved halfway into the central hole of the compact disk;

FIG. 10 shows the retaining lugs have been fully moved into the central hole of the compact disk to interfere with the central hole;

FIG. 11 shows the manner of removing the retaining lugs from the compact disk;

FIG. 12 is a perspective view of a pen with structure for picking up compact disk according to a second embodiment of the present invention;

FIG. 13 is a top view of the pen of FIG. 12 showing a plurality of retaining lugs are provided on an end of the pen for picking up a compact disk; and

FIG. 14 is a sectional view taken along line b-b of FIG. 13.

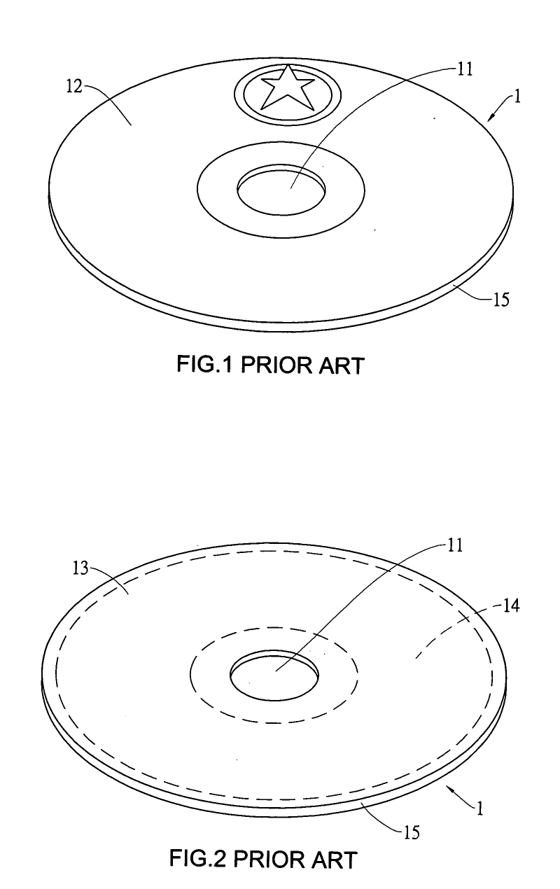

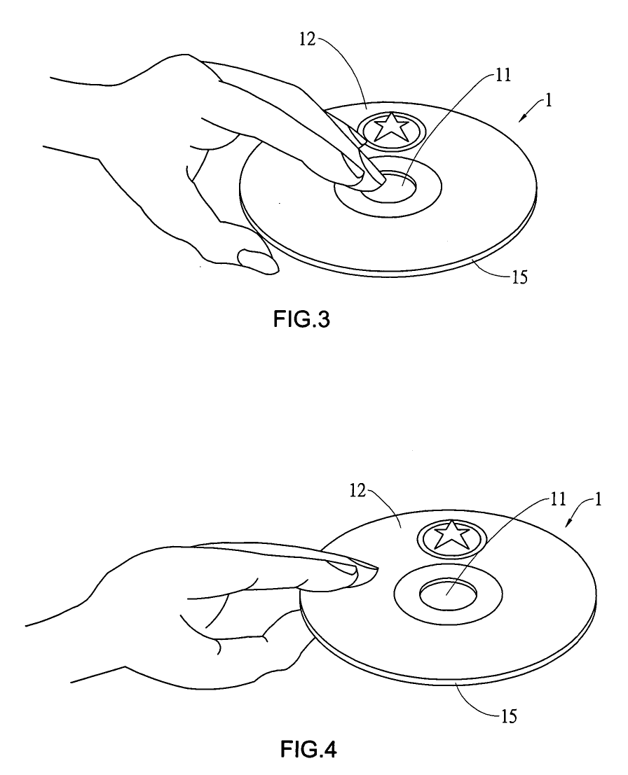

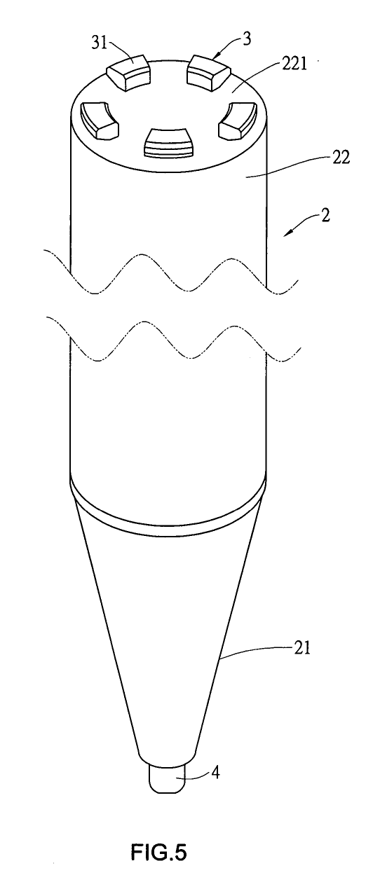

### DETAILED DESCRIPTION OF THE PREFERRED EMBODIMENTS

Please refer to FIG. 5 that is a perspective view of a pen with structure for picking up compact disk according to a preferred embodiment of the present invention. As shown, the pen, which is generally denoted with a reference numeral 2, includes a first end 21 and a second end 22 distantly opposite to the first end 21. One of the first and the second end 21, 22 is provided at an end surface thereof with an engaging mechanism 3, while the other end is provided with a writing element 4. In the illustrated preferred embodiment, the engaging mechanism 3 is provided on an flat end surface 221 of the second end 22, and the writing element 4 is provided on the first end 21.

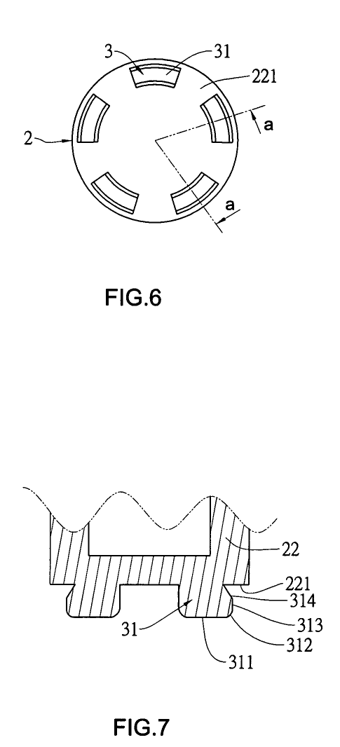

Please refer to FIG. 6 that is a top view of the pen 2 showing the second end 22 thereof. As shown, the engaging mechanism 3 includes a plurality of retaining lugs 31 that are axially projected from the end surface 221 of the second end 22 of the pen 2 and angularly equally spaced along an outer circumferential edge of the end surface 221. A predetermined small distance is left between an outer circumference defined by the retaining lugs 31 and the outer circumferential edge of the end surface 221.

As can be clearly seen from FIG. 7, which is a sectional view taken along line a-a of FIG. 6, each of the retaining lugs 31 includes a horizontal end surface 311 raised from the end surface 221 of the pen 2 to serve as a push zone, against which a force may be applied to cause a radially inward deflection of the retaining lug 31; a loose contact section 312 adjacent to an outer side of the end surface 311 and in the form of a rounded corner; an interfere section 313 immediately located behind the loose contact section 312 and in the form of a vertical flat surface; and a tapered section 314 axially inward extended from the interfere section 313 toward a center of the end surface 221 of the pen 2 at a predetermined inclination. The loose contact section 312 in the form of a rounded corner enables the retaining lug 31 to pass through a central hole 51 of a compact disk 5 easily. However, it is understood the loose contact section 312 may be of any other suitable form, such as a chamfered corner.

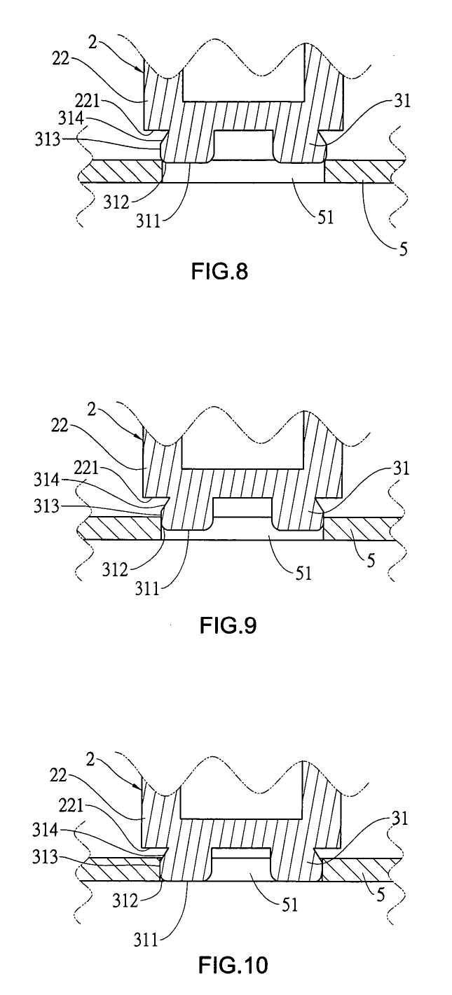

Please refer, to FIGS. 8 to 10 that shows how the pen 2 of the present invention is operated to pick up a compact disk 5. As can be seen from FIG. 8, the compact disk 5 has a central hole 51. To pick up the compact disk 5 with the pen 2, first direct the second end 22 of the pen 2 toward the compact disk 5, with the retaining lugs 31 on the second end 22 of the pen 2 aligned with the central hole 51 of the compact disk 5. Then, apply an axial force to push the pen 2 against the central hole 51 of the compact disk 5, so that all the loose contact sections 312 of the retaining lugs 31 are moved through the central hole 51 of the compact disk 5.

As shown in FIGS. 9 and 10, when the pen 2 is kept moved forward after the loose contact sections 312 of the retaining lugs 31 have passed the central hole 51 of the compact disk 5, the interfere sections 313 of the retaining lugs 31 are brought to contact with and be radially inward pushed by an inner circumferential wall of the central hole 51, until the pen 2 stops moving any further. At this point, the interfere sections 313 produce an interfering force, that is, a push force against the central hole 51, so that the compact disk 5 is held to the retaining lugs 31, allowing the pen 2 to pick up the compact disk 5.

The tapered sections 314 on the retaining lugs 31 allow the compact disk 5 to more smoothly axially move along the retaining lugs 31. And, the end surface 221 of the pen 2 forms a limit to an axial travel of the compact disk 5.

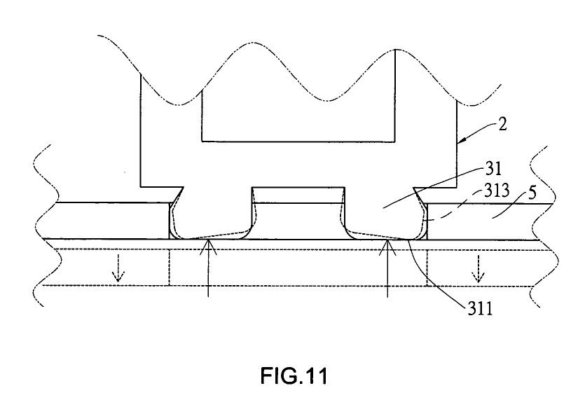

Please refer to FIG. 11. To remove the compact disk 5 from the pen 2, simply apply an axial force against the push zones, that is, the end surfaces 311 of the retaining lugs 31, so that the retaining lugs 31 are brought to move radially inward, and the interfering force produced by the interfere sections 313 against the inner circumferential wall surface of the central hole 51 of the compact disk 5 is removed. At this point, the compact disk 5 is no longer firmly held to the retaining lugs 31 of the engaging mechanism 3, and can be easily separated from the pen 2.

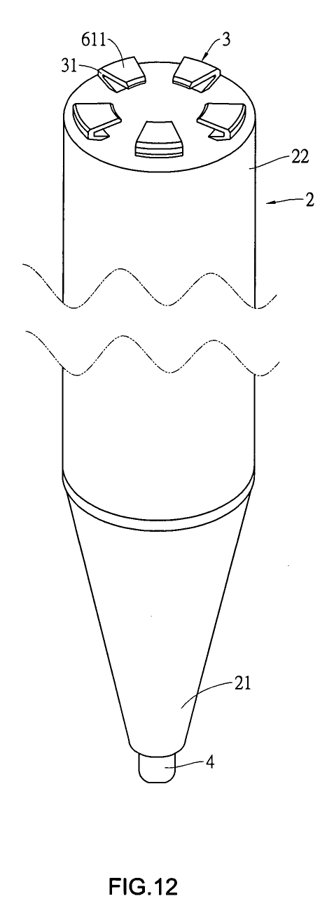

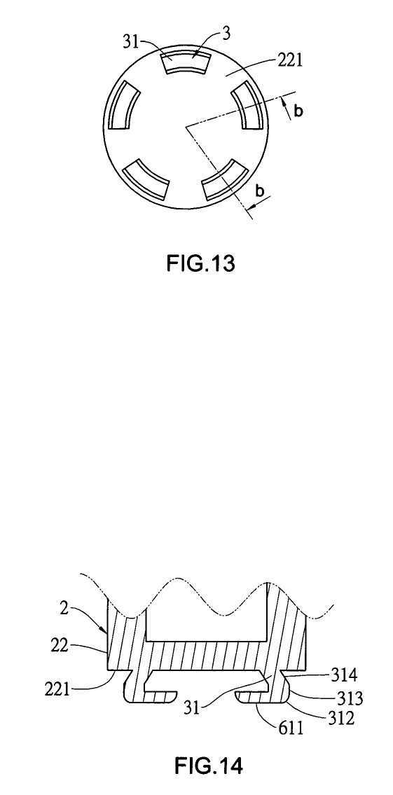

FIG. 12 is a perspective view of a pen with structure for picking up compact disk according to a second embodiment of the present invention, and FIG. 13 is a top view thereof. The second embodiment is generally structurally similar to the first preferred embodiment, except for the retaining lugs 31. As can be clearly seen from FIG. 14 that is a sectional view taken along line b-b of FIG. 13, each of the retaining lugs 31 in the second embodiment includes a substantially horizontal suspension arm 611 radially inward extended from the loose contact section 312 toward the center of the pen 2 to serve as the push zone. When an axial force is applied against the suspension arms 611, the suspension arms 611 are brought to axially deflect, which in turn brings the retaining lugs 31 to radially inward deflect. Since the retaining lugs 31 of the second embodiment work in the same manner as the first embodiment, the operation thereof is not repeated herein.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A pen with structure for picking up compact disk, said compact disk having a central hole, and said pen comprising a first end, a second end distantly opposite to said first end, and an engaging mechanism provided on an end surface of one of said first and said second end; and said engaging mechanism defining an outer circumference adapted to interfere with an inner circumference of said central hole of said compact disk.

2. The pen with structure for picking up compact disk as claimed in claim 1, wherein said engaging mechanism includes a plurality of retaining lugs that are axially projected from said end surface of said pen and angularly equally spaced along an outer circumferential edge of said end surface, with a predetermined small distance left between said outer circumference defined by said retaining lugs and said outer circumferential edge of said end surface.

3. The pen with structure for picking up compact disk as claimed in claim 2, wherein each of said retaining lugs includes a push zone raised from said end surface of said pen; a loose contact section adjacent to an outer side of said push zone for guiding said retaining lug to pass through said central hole of said compact disk; an interfere section immediately located behind said loose contact section and adapted to contact with said inner circumference of said central hole of said compact disk to produce a push force against said central hole to thereby hold said compact disk to said retaining lug; and a tapered section axially inward extended from said interfere section toward a center of said end surface of said pen at a predetermined inclination, enabling said compact disk to axially move along said retaining lug.

4. The pen with structure for picking up compact disk as claimed in claim 3, wherein said loose contact section is in the form of a rounded corner.

5. The pen with structure for picking up compact disk as claimed in claim 3, wherein said loose contact section is in the form of a chamfered corner.

6. The pen with structure for picking up compact disk as claimed in claim 3, wherein said interfere section is a vertical flat surface.

7. The pen with structure for picking up compact disk as claimed in claim 3, wherein said push zone is a horizontal end surface of a projected outer end of said retaining lug, against which an axial force may be applied to cause a radially inward deflection of said retaining lug.

8. The pen with structure for picking up compact disk as claimed in claim 3, wherein said push zone is a substantially horizontal suspension arm radially extended from a projected outer end of said retaining lug toward the center of said pen, such that said suspension arm is axially deflected to bring said retaining lug to radially inward deflect when a force is axially applied to said suspension arm.

9. The pen with structure for picking up compact disk as claimed in claim 1, wherein said end surface of said pen provided with said engaging mechanism is a flat surface.

10. The pen with structure for picking up compact disk as claimed in claim 2, wherein said end surface of said pen provided with said engaging mechanism is a flat surface.

11. The pen with structure for picking up compact disk as claimed in claim 3, wherein said end surface of said pen provided with said engaging mechanism is a flat surface.

12. The pen with structure for picking up compact disk as claimed in claim 1, wherein said end of said pen without said engaging mechanism is provided with a writing element.
